(19) United States
(12) Patent Application Publication
(10) Pub. No.: US 2004/0074136 A1
(43) Pub. Date: Apr. 22, 2004

(54) Fish-hook holder

(76) Inventor: Gregory Moss, Bronx, NY (US)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/277,705

(22) Filed: Oct. 22, 2002

(51) Int. Cl. A01K 97/06

(52) U.S. Cl. 43/57.1

(57) ABSTRACT

A plurality of fish hooks each having a barbed end and an opposite end from which a flexible leader extends are carried on a fish-hook holder having an elongated body having a pair of end faces and a side wall forming a corner at each of the end faces. The body is formed at the corner between the side wall and one of the ends faces with a plurality of narrow slits. Each of the hooks has its barbed end engaged in the other end face and its leader extending from the other end face along the side wall to the opposite end face and frictionally engaged in a respective one of the slits.

### FIELD OF THE INVENTION

The present invention relates to fish-hook holder. More particularly this invention concerns such a holder for a plurality of fish hooks with their leaders.

### BACKGROUND OF THE INVENTION

A fish hook has a barbed end and at its opposite end an eye that is connected to a short leader, typically a permanently mounted piece of monofilament. The hook can be of various sizes and be dressed up with feathers and the like for fly fishing. Such a hook is typically supplied to the user in an envelope with its leader.

When such a hook it not in use, it is typically stored in a tackle box. Unless the user meticulously winds up the leader, the result is normally a messy tangle. Even if the leader is carefully wound, the hook is still exposed and eventually separating the various hooks from each other becomes very difficult.

It has been proposed, for example in U.S. Pat. No. 4,186,511 of Slacter or U.S. Pat. No. 4,742,640 of Moore, to provide a pad constituted of a block of elastomeric material that can be mounted on the gunwale of a boat for temporary storage of fish hooks and lures. Such a system provides a moderately neat way to keep track of the equipment that is being used, but still leaves the leaders dangling and is not applicable to long-term storage of fish hooks in a tackle box.

### OBJECTS OF THE INVENTION

It is therefore an object of the present invention to provide an improved fish-hook holder.

Another object is the provision of such an improved fish-hook holder which overcomes the above-given disadvantages, that is which allows a plurality of fish hooks to be stored in a neat manner that prevents them from getting tangled together while still allowing an individual hook and its leader to be separated for use when needed.

### SUMMARY OF THE INVENTION

A plurality of fish hooks each having a barbed end and an opposite end from which a flexible leader extends are carried on a fish-hook holder having according to the invention an elongated body having a pair of end faces and a side wall forming a corner at each of the end faces. The body is formed at the corner between the side wall and one of the ends faces with a plurality of narrow slits. Each of the hooks has its barbed end engaged in the other end face and its leader extending from the other end face along the side wall to the opposite end face and frictionally engaged in a respective one of the slits.

With such a holder, the leaders are therefore not going to get tangled together, as they extend straight along the side wall of the holder which is dimensioned so that only a short length of each leader dangles from the one end face. Thus a plurality of hooks with their leaders are maintained in very good order, but taking one off the holder and putting it back on is a simple one-handed task. The holder carrying a plurality of hooks and their leaders can be tossed in a tackle box where it will be safe and ready for use.

The body ends in accordance with the invention are substantially planar and parallel. More particularly, the side wall extends as a family of parallel lines substantially perpendicular to the end walls. Thus the body can be cylindrical or of polygonal section.

In a particularly practical embodiment, the body is formed of a cylindrical block of pierceable and elastically deformable material, for instance a closed-cell polyurethane foam. It can carry decoration or advertising.

The other end face can be formed in accordance with the invention adjacent the respective corner with an array of holes each aligned with a respective one of the slits. In addition the side wall is provided with a respective line extending from each slit to the other end face to ensure that the leaders are not crossed.

### BRIEF DESCRIPTION OF THE DRAWING

The above and other objects, features, and advantages will become more readily apparent from the following description, reference being made to the accompanying drawing in which:

FIG. 1 is a perspective view of the fish-hook holder according to the invention; and

FIG. 2 is an axial section through the holder of FIG. 1.

### SPECIFIC DESCRIPTION

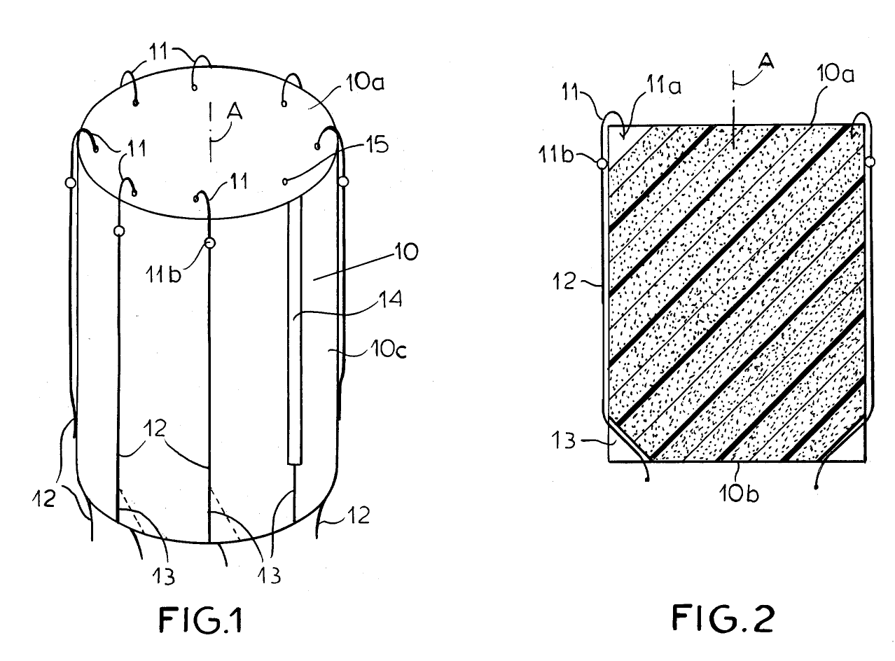

As seen in FIGS. 1 and 2, a fish-hook holder according to the invention basically comprises a cylindrical block 10 of closed-cell urethane foam centered on an axis A and having a pair of planar and parallel end faces 10a and 10b and a cylindrical outer side wall 10c. J-shaped fish hooks 11 have barbed points 11a, eyes 11b, and monofilament leaders 12 extending from the eyes 11b.

In accordance with the invention the hooks 11 are poked into the end face 11a with their eye ends 11b lying against the side wall 10c and their leaders 12 extending down along this side wall 10c. At the corner where the side wall 10c meets the face 10b, the block 10 is formed with an array of angled slits 13 having floors extending at 45° to the axis A. The leaders 12 are each fitted to a respective one of the slits 13 so that they are fairly taut and lie flat along the side wall 10c, with the short end of each leader 13 dangling past the bottom face 10b.

The face 10a may be preformed with small holes 15 for insertion of the barbed ends 11a of the hooks 11 and each aligned axially with a respective one for the slits 13. The side walls may carry stripes 14 aligned between each of the holes 15 and the respective slit 13 so that the user can easily determine which slit 13 should be used for each hole 15.

To mount a fish hook 11 with its leader 12 on the holder according to the invention, the user merely pokes the barbed end 11a of the hook 11 into the face 10a, either into a hole 15 formed therein or just into the imperforate face 10a of the block 10. The leader 12 is then pulled taut down along the side wall 10c and is fitted to the slit 13 where it is held by friction, as the slits 13 are formed as simple cuts with no removal of material. When the hook 11 is needed, the user need merely grip the short dangling end of the leader 13, pull it radially out of its slit 13, and then pull the hook 11 axially up out of the block 10.

The holder according to the invention can carry a plurality of hooks, here eight. It can be dropped in a tackle box while carrying such a number of hooks and will retain them in usable condition, not tangled with each other. The side wall 10c can carry decoration or advertising.

I claim:

1. In combination with a plurality of fish hooks each having a barbed end and an opposite end from which a flexible leader extends, a fish-hook holder comprising:
an elongated body having a pair of end faces and a side wall forming a corner at each of the end faces, the body being formed at the corner between the side wall and one of the ends faces with a plurality of narrow slits, each of the hooks having its barbed end engaged in the other end face and its leader extending from the other end face along the side wall to the opposite end face and frictionally engaged in a respective one of the slits.

2. The combination defined in claim 1 wherein the ends are substantially planar and parallel.

3. The combination defined in claim 2 wherein the side wall extends as a family of parallel lines substantially perpendicular to the end walls.

4. The combination defined in claim 3 wherein the side wall is cylindrical.

5. The combination defined in claim 3 wherein the body is formed of a block of pierceable and elastically deformable material.

6. The combination defined in claim 5 wherein the material is a synthetic-resin foam.

7. The combination defined in claim 1 wherein the other end face is formed adjacent the respective corner with an array of holes each aligned with a respective one of the slits.

8. The combination defined in claim 1 wherein the side wall is provided with a respective line extending from each slit to the other end face.

9. The combination defined in claim 1 wherein each slit opens at the side wall and at the one end face.
